(19) United States
(12) Patent Application Publication
(10) Pub. No.: US 2016/0099981 A1
(43) Pub. Date: Apr. 7, 2016

(54) METHOD FOR FILTERING SECTIONS OF SOCIAL NETWORK APPLICATIONS

(71) Applicant: Iou-Ming Lou, Taipei (TW)

(72) Inventor: Iou-Ming Lou, Taipei (TW)

(21) Appl. No.: 14/506,606

(22) Filed: Oct. 4, 2014

(51) Int. Cl. H04L 29/06; G06F 3/0481; G06F 3/0485; H04L 12/58; G06F 3/0482

(52) U.S. Cl. CPC H04L 65/403; H04L 51/32; G06F 3/0482; G06F 3/0485; G06F 3/04817

(57) ABSTRACT

A method for setting viewing options in a social network application is disclosed. First, a plurality of sections are provided. Second, a first order for the plurality of sections is provided wherein the sections are in the first order. Then an image icon to represent the user is provided. Next, a selection icon is provided for the viewing user to select, wherein when the selection icon is selected, the piece of content information is secured and the section is secured. Next, a plurality of secured sections is collected the secured sections is displayed in a second order.

### CROSS-REFERENCE TO RELATED APPLICATIONS

The present application claims the benefit of priority to U.S. Provisional Application No. 61/887,272, filed Oct. 4, 2013. The content of the provisional application is incorporated herein by reference in its entirety.

### FIELD OF THE INVENTION

The present application relates to social network applications. More particularly, the present application relates to setting viewing options for a viewing user in a social network applications.

### BACKGROUND OF THE INVENTION

Social network service can allow a plurality of users to share their information through the Internet. A viewing user can use a mobile device to view sections that are posted by other users. The sections can contain messages, photos, links, and videos. The viewing user can choose to reply to a certain posted sections so that the social network service become a convenient and fast way to interact with other users. Usually a social network application is installed into the mobile device and the viewing user can initiate the social network application and check newly posted sections from other users. However, with the increasing number of users and posted sections, viewing posted sections become a burden for the viewing user. A new and efficient way is needed to solve the problem.

### SUMMARY OF THE INVENTION

One objective of the invention is to increase the efficiency for a viewing users to view posted sections from other users in a social network application.

Another objective of the invention is to save memory space and time for a social network application.

Still another objective of the invention is to help a viewing user to rearrange a sequence of displaying sections of a social network application.

According to one aspect of the invention, a method for interactions between a viewing user and a social network application is disclosed. First, a first section on a screen of the mobile device is shown. Next, a second section next to the first section is arranged. The second section is associated with a second user. Next, a third section next to the second section is arranged. The third section is associated with a third user. Next, first content information is displayed in the first section. Next, a selection icon for the viewing user to select is displayed, wherein when the selection icon is selected, the content information is secured for a later review and the section is secured. The first section, the second section, and the third section are arranged in a sequence so that when the viewing user touches the screen to scroll, the first section, the second section, and the third section move on the screen in a same movement in response to the scrolling.

According to another aspect of the invention, a method for setting viewing options in a social network application is disclosed. First, a plurality of sections are provided, wherein each section is corresponding to a piece of content information and the piece of content information is provided by one of the plurality of users of the social network application. Next, a first order for the plurality of sections is provided so that when the plurality of sections are displayed on an screen of the mobile device, the sections are in the first order. Next, an image icon is provided to represent the user. Next the image icon within the section is displayed when the section is displayed on the screen of the mobile device. Next, a selection icon for the viewing user to select is provided, wherein when the selection icon is selected, the piece of content information is secured and the section is secured. Next a plurality of secured sections are collected. Next the secured sections are displayed in a second order when the viewing user chooses to display the secured sections on the mobile device.

According to still another aspect of the invention, a method for filtering content information in a social network application is disclosed. First, a plurality of pieces of content information are collected. The plurality of pieces of content information are transmitted by the plurality of corresponding users. Next, the plurality of pieces of content information is filtered to generate a first sequence of sections for displaying on a mobile device. Each section is corresponding to one of the plurality of pieces of content information and each section comprises an image icon representing the user that provides the corresponding piece of content information. Next, the securing option to each section is provided so that a viewing user is allowed to select to secure the corresponding section and to secure the corresponding section. Next, a result of securing options is collected for the plurality of sections. Next, the sections corresponding to the result of securing options are displayed in a second sequence in response to a request made by the viewing user, the first order being different from the second order.

### BRIEF DESCRIPTION OF THE DRAWINGS

FIG. 1 shows a screenshot of a mobile device that displays image components of multiple users of a social network application;

FIG. 2 shows an enlarged image component 106;

FIG. 3 show a front page of a social network application that runs on a mobile device;

FIG. 4 shows a screenshot of the mobile device 100 that allows the user to set priorities of other users;

FIG. 5 shows that different users can be grouped and assigned to a priority value;

FIG. 6 shows a graphical interface for the user to adjust priority values for other users;

FIG. 7 shows a sequence of sections that displaying information from other users;

FIG. 8 shows an embodiment of securing or skipping sections;

FIG. 9 shows an embodiment of securing or skipping sections according to the corresponding users;

FIG. 10 shows an embodiment of displaying viewing status on sections;

FIG. 11 shows wired and wireless connections between a mobile device and the Internet;

FIG. 12 shows basic blocks in a mobile device;

FIG. 13A shows an embodiment of securing or skipping sections;

FIG. 13B shows another embodiment of securing or skipping sections;

FIG. 13C shows another embodiment of securing or skipping sections;

FIG. 13D shows an embodiment of displaying a selection icon;

FIG. 14 shows a page that helps to analyze the number of sections posted by different users;

FIG. 15A shows an initial page of a social network application;

FIG. 15B shows a next page after the user logs onto the social network application;

FIG. 16 shows the relationship between different groups and different users;

FIG. 17 shows one embodiment of the mobile device's interaction with the Internet and the server;

FIG. 18 shows internal modules of the mobile device 100 for one embodiment;

FIG. 19 shows modules contained in a software component;

FIG. 20 shows a review icon displayed;

FIG. 21 shows an arrangement of sections that can be displayed on a screen of a mobile device; and

FIG. 22 shows an embodiment of changing screen views.

### DETAILED DESCRIPTION OF THE PREFERRED EMBODIMENTS

A social network application can be a group of codes that is executable on a mobile device. The social network application is capable of showing a plurality of continuing sections. Each of the sections is associated with one of a plurality of users and comprises a piece of posted information.

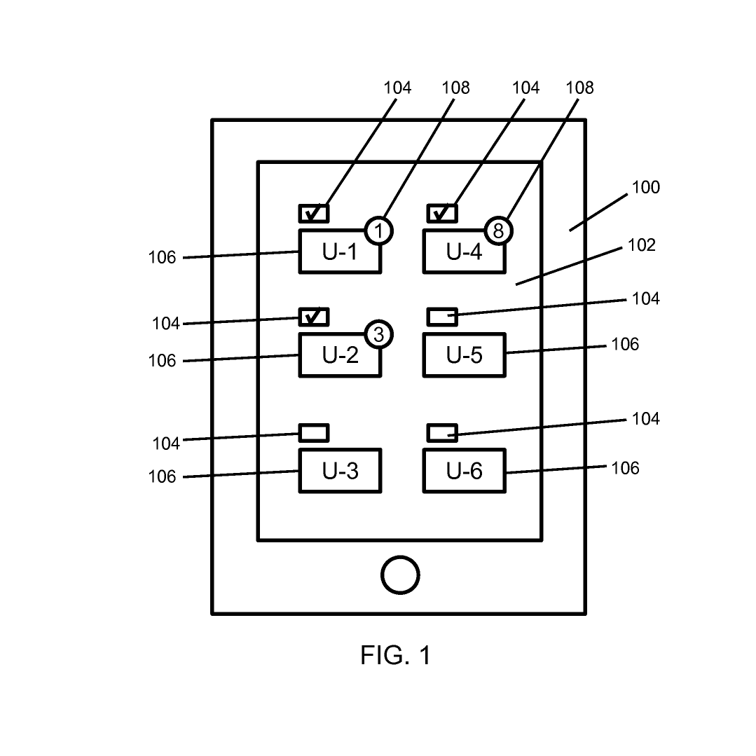

FIG. 1 shows a screenshot of a mobile device that displays image components of multiple users of a social network application. Image components 106 are displayed on a screen 102 of a mobile device 100. The mobile device 100 can be a cell phone. The image components 106 can represent different users that use the social network application. For example, image components 106 of six users U-1, U-2, U-3, U-4, U-5, U-6 are shown on the screen 102.

In this embodiment, each of the image component 106 has two sub image components 104 and 108. The subcomponent 104 is a check box for an user to select. When the user checks the checkbox associated with the image component of the user U-1, it represents that the content provided by the user U-1 is chose to be displayed. When the checkbox is unchecked, it represents that the content provided by the user U-1 is chose not to be displayed.

The sub image component 108 shows a number of pieces of content the user U-1 newly provided. For example, the number “1” is displayed on the sub image component 108. It represents that one new piece of information from the user U-1 is updated. The user can know how much content will be displayed when he chooses to allow it to be displayed on the screen.

In this embodiment, the users U-1, U-2, U-4, U-6 have newly updated information while the users U-3 and U-5 do not have newly updated information.

By allowing the user to select whether to display content from certain users, the whole system can save huge amount of storage space and bandwidth. The whole system needs not to prepare all materials from all other users that are associated with the user.

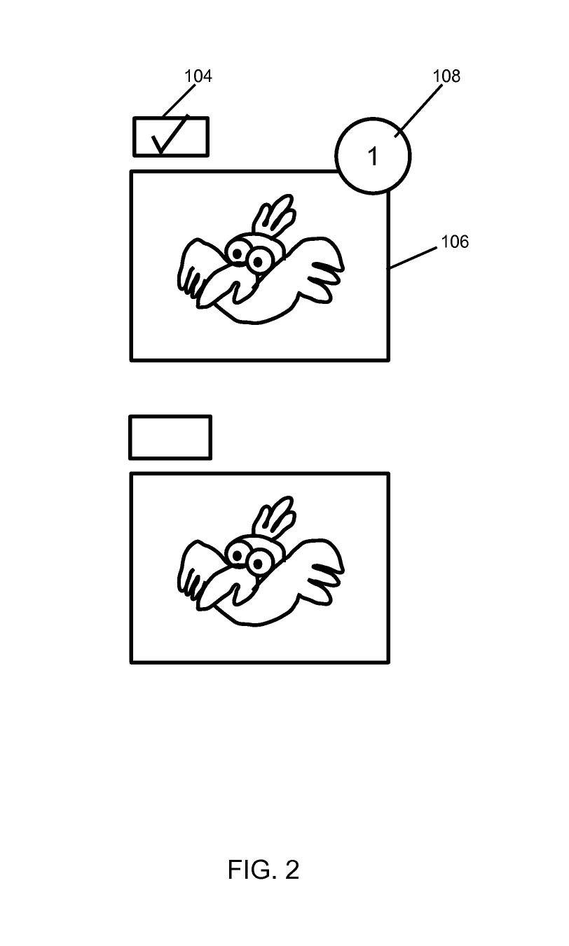

FIG. 2 shows an enlarged image component 106. The image component 106 represents a specific user. The specific user can use a special image to represent itself An image of bird is used in this example. Two sub image components 104 and 108 are also shown in FIG. 2. The sub image component 104 is a checkbox. When the checkbox is checked (the upper portion of FIG. 2), the materials from the specific user are chose to be displayed later. When the checkbox is not checked (the lower portion of FIG. 2), the materials from the specific user are chose not to displayed later.

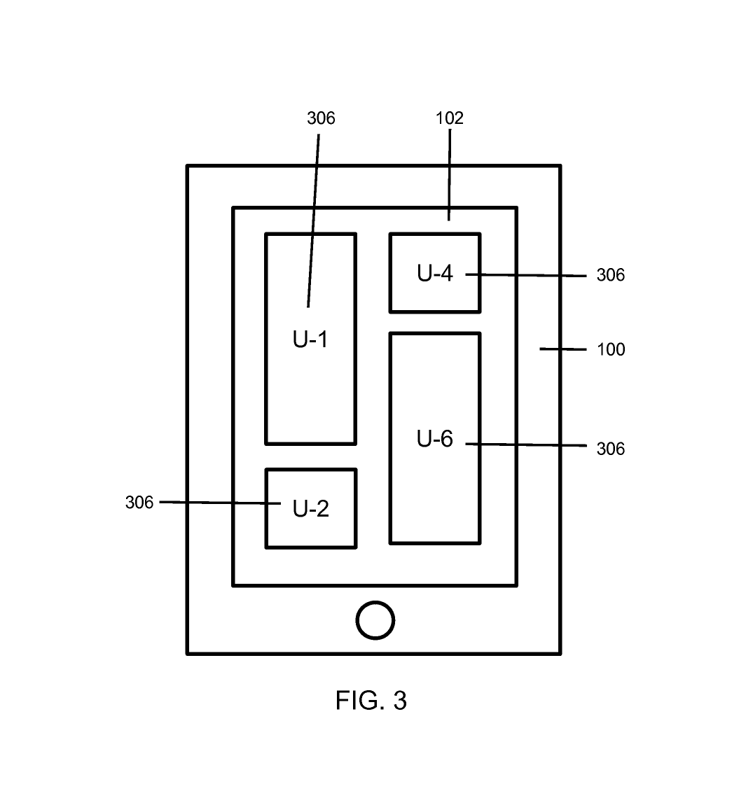

FIG. 3 show a front page of a social network application that runs on a mobile device. A social network application can be executed on the mobile device 100. The front page can show only information from certain users. The certain users are predefined by the user. The front page has multiple sections 306. Each section 306 can be used to display newly updated information from a specific user. For example, information from the users U-1, U-2, U-4, and U-6 are displayed. The sections have different sizes. The size of a specific user is dependent on how much new information needs to be shown on the screen 102. The social network application can calculate the size of the information and then allocate suitable space for it.

Sometimes sections 306 of the front page is not enough to display all materials. In this case the sections 306 can display only lists or outline of the information. If the user wants to see details of a specific user, such as the user U-1, the user can further select the user and then details of the information provided by the user U-1 can be displayed accordingly.

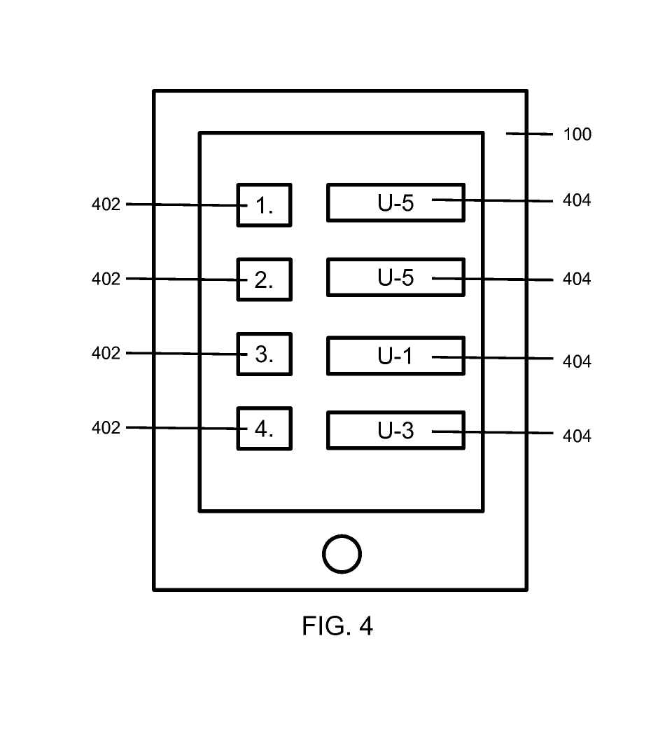

FIG. 4 shows a screenshot of the mobile device 100 that allows the user to set priorities of other users. In this embodiment, the mobile device 100 provides an interface for the user to set priorities for different users U-5, U-6, U-1, and U-3. The image components 402 shows different priority values that represent different priorities for different users. Image components 404 represents different users U-5, U-6, U-1, and U-3 respectively.

For example, the priority value “1” is assigned to the user U-5. It represents that the user U-5 has the highest priority. The information provided by the user U-5 will be displayed first on the mobile device 100 when the user updates the social network application.

Similarly, the priority value “2” is assigned to the user U-6. It represents that the user U-1 has a second priority. The information provided by the user U-6 will appear at a second place following the user U-5, and so on.

The priority values “3” and “4” are respectively assigned to the user U-1 and the user U-3. That means while the information from the users U-5, U-6, U-1, and U-3 is displayed, it will follow a sequence based on the priority values.

That is, information from the user with a higher priority is displayed ahead of that from the user with a lower priority.

In this way, the user who updates the social network application will see the most important information first and see the less important information later.

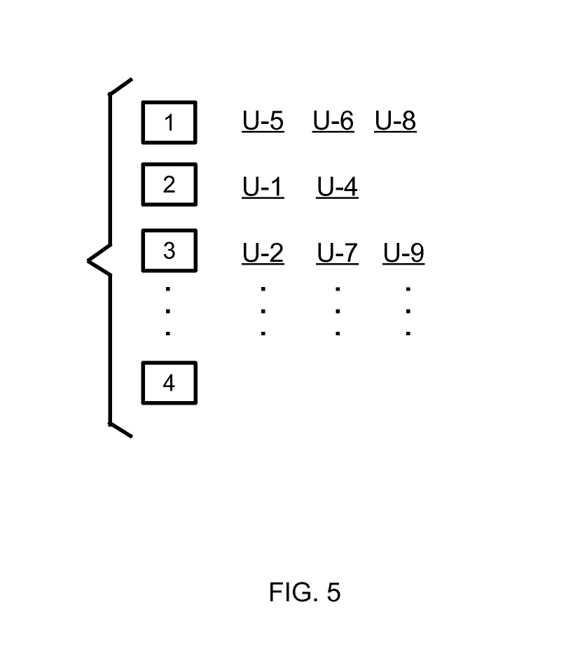

FIG. 5 shows that different users can be grouped and assigned to a priority value. Priority values “1, 2, 3, . . . , N” are predefined. The users U-5, U-6, and U-8 are grouped and assigned to the priority value “1”. The users U-1 and U-4 are grouped and assigned to the priority value “2.” The users U-2, U-7, and U-9 are grouped and assigned to the priority value “3,” and so on. It represents that the users U-5, U-6, and U-8 have the same priority, but the priority is higher than that of the users U-1 and U4. The sequence of priority values “1, 2, . . . , N” represent priorities of users from high to low. The priority value “1” denotes the highest priority and the priority value “N” denotes the lowest priority.

The information provided by a user with a higher priority can be displayed at an earlier time than that provided by a user with a lower priority. In another embodiment, The information provided by a user with a higher priority can be displayed at an upper position than that provided by a user with a lower priority.

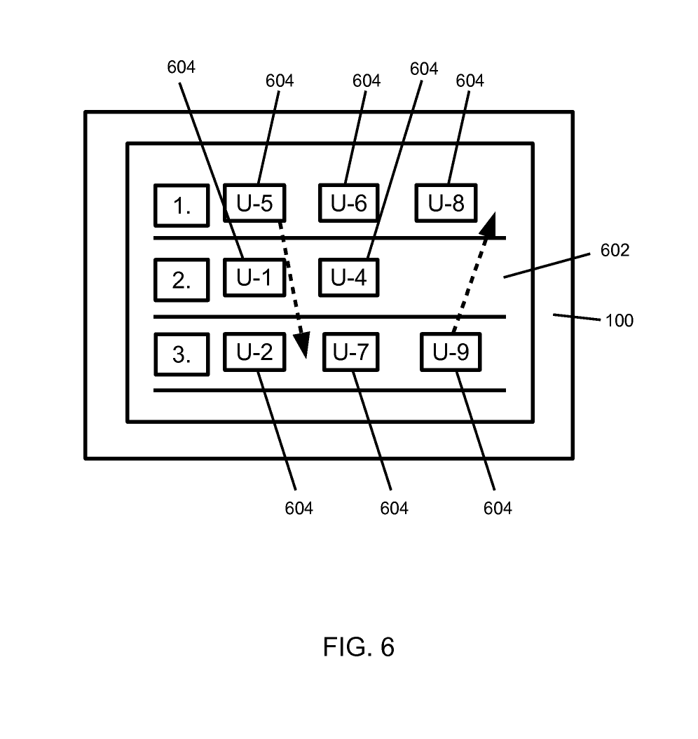

FIG. 6 shows a graphical interface for the user to adjust priority values for other users. The graphical interface 602 can be shown on the mobile device 100. In this embodiment, priority values (e.g., 1, 2, and 3) are listed at the left column. Image components 604 represent different users. The users U-6, U-6, and U-8 are listed on the first row and are to the priority value 1. The users U-1 and U-4 are listed on the second row and are assigned to the priority value 2. The users U-2, U-7, and U-9 are listed on the third row and are assigned to the priority value 3. The priority value 1 represents the highest priority. The priority value 2 represents the second priority, and so on.

The user can change the priority of one of the users by moving the associated image component 604 to a different row. For example, the user can touch the image component U-5 and move the image component U-5 from the first row to the third row and then release it. The priority value of the user U-5 is now changed from 1 to 3. Similarly, when the user moves the image component U-9 from the third row to the first row, he changes the priority value of the user U-9 from 3 to 1. By touching and moving image components of different users, the current user can change the settings of priority values to other users and make his preferred arrangement.

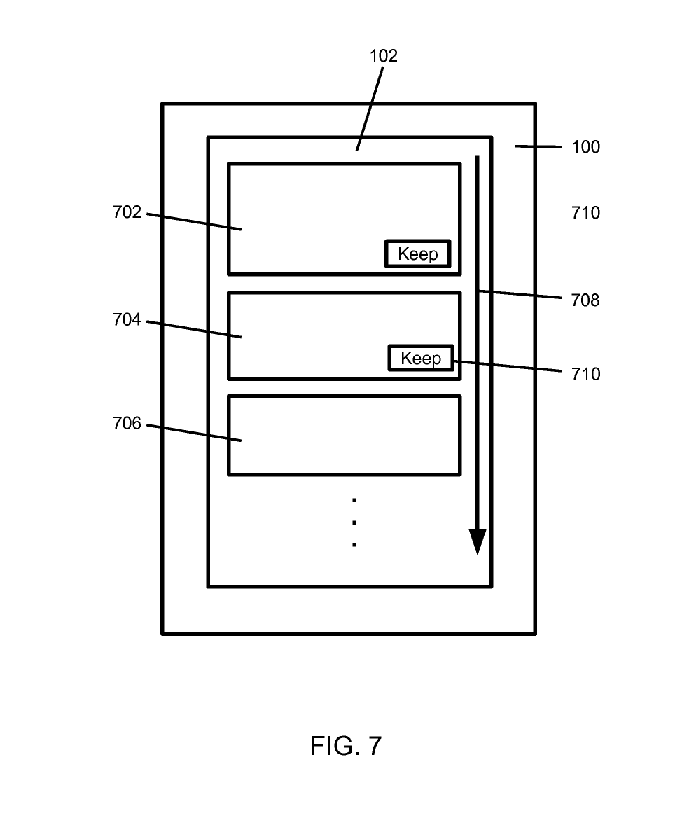

FIG. 7 shows a sequence of sections that displaying information from other users. Sections 702, 704, and 706 display information provided by users. For example, the section 702 may display a photograph provided by the user U-1. The section 704 may display a piece of text from the user U-2. The section 706 may display a hyperlink the user U-3 provides. The current viewing user can be different from the users U-1, U-2, and U-3. The order of displaying sections can be determined by the time record that each section is posted. For example, a section posted earlier may be displayed in an upper position while a section posted later may be displayed in a lower position.

The current user may want to keep some sections and skip some other sections. If there are too many sections displayed on the mobile device 100, the user may want to first do a quick review and select sections he wants to review in detail and remove other unwanted sections. A small icon 710 can be displayed on a corner of one section to allow the user to keep or delete the section. For example, an icon “Keep” is displayed on the section 702. When the user wants to see the section 702 next time, he can touch this “Keep” icon so that the section 702 will be stored. The section 702 will be displayed when the user activates the social network application next time. In some cases, when the viewing user select the “Keep” icon, the corresponding section is secured. In some embodiments, the corresponding section is merely tagged or marked so that the section can be displayed in response to the viewing user's request.

In another embodiment, an icon “SKIP” is shown on one corner of the section 704. When the user touches to select the icon “SKIP,” the social network application is instructed to remove the section 704. The section 704 will not be displayed when the social network application is activated again.

After selection by the users, the amount of information needed to be displayed is reduced and memory spaces can be saved.

In one embodiment, the icons 710 and 708 need not to be always displayed. For example, the icons 710 can be displayed when the user taps once on the section 702. The user can then choose to keep or skip the section 702. In this manner, the user will not be bothered by the icons 710 when he/she is viewing sections 702, 704, and 706.

When an user slides to scroll on the screen 102 in the direction 708 , the sections 702, 704, and 708 may have the same movement and go with the scrolling action. The viewing user can view sections 702, 704, 706 and also other sections that are not shown in FIG. 7.

When the viewing user chooses to secure the section 702 and the section 704 and chooses to skip the section 706, then when next time the viewing user renews the sections, the section 702 and the section 704 are displayed but the section 706 is not displayed. In another embodiment, the viewing user can choose to select a review icon in another page of the social network application to show all secured sections. The original sections 702, 704, and 706 are in a first order or sequence. The rearranged sections 702, 704 are in a second order or sequence. In another embodiment, the sections 702 and 706 are secured while the section 704 is skipped. In this case the original order is sections 702, 704, and 706 while the second order is sections 702 and 704. That is, when a viewing user inputs a factor of securing or skipping to the social network application, then the social network application can arrange the displaying of the sections from the first order (displaying all sections) to the second order (displaying only the secured sections).

Usually the time of positing a section can be a factor for determining the first order. For example, if the time of posting the section 702 is later than the time of posting the section 704, then the section 702 can be displayed at a higher position than the section 704. That is, if the time sequence is sections 702, 704, and 706, so is the displaying sequence on the screen of the mobile device.

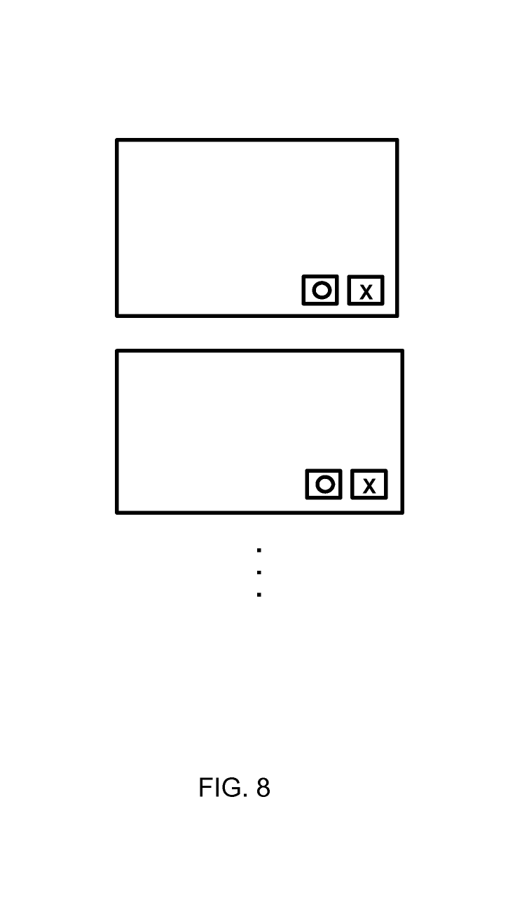

FIG. 8 shows an embodiment of securing or skipping sections. In this embodiment, a selection icon “O” is displayed for the viewing user to select. If the viewing user chooses to touch to select the selection icon “O,” the corresponding section is secured. The social network application can mark or tag the section so that the section can be “remembered” and can be displayed again in response to the viewing user's request. If the viewing user chooses to touch to select the skipping icon “X,” then the corresponding section is skipped. The corresponding section can be tagged or marked by the social network application so that when the viewing user tries to update all the sections, the skipped sections are not displayed. The skipping option can be permanent or temporary. If a permanent skipping is selected, the corresponding section may be removed from a local memory space in the mobile device. If a temporary skipping is selected, then the corresponding section may merely be marked or tagged so that the social network application can recognize the sections so that the sections may not be displayed in the next renewal of posted sections. However, the temporary skipping can be recovered and then the corresponding sections can be displayed in response to the request made by the viewing user. In this case, the corresponding sections are still stored in the local memory space in the mobile device.

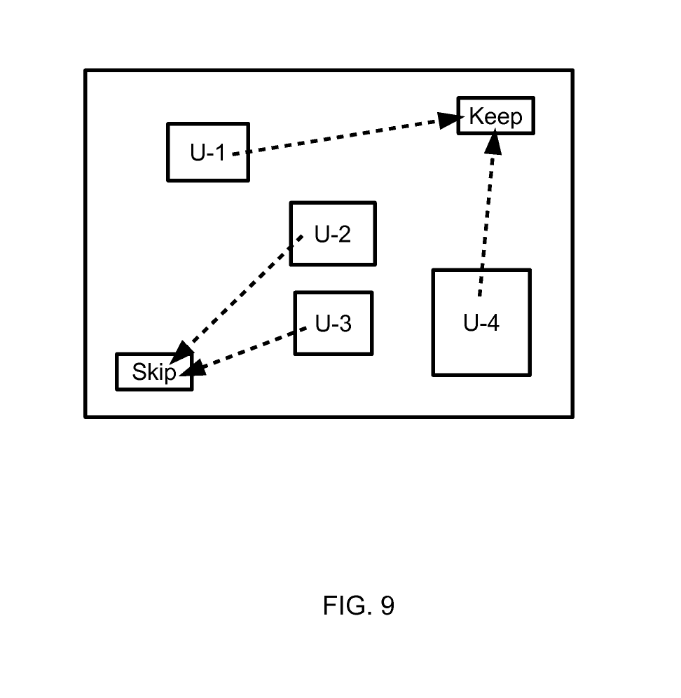

FIG. 9 shows an embodiment of securing or skipping sections according to the corresponding users. With reference to FIG. 9, users U-1, U-2, U-3, and U-4 can be shown on the screen of the mobile device. In this case, an icon “Keep” is displayed on the same screen so that when a viewing user chooses to drag a user to the “Keep” icon, then the sections posted by the user is secured. An icon “Skip” is also displayed on the screen of the mobile device. When the viewing user chooses to drag a user to the “Skip” icon, then the corresponding sections are skipped and may not be displayed in the next renewal of sections. In some embodiments, the U-1, U-2, U-3, and U-4 shown in FIG. 9 merely represent users and do not display content information that is posted by the corresponding users. However, in other embodiments, the U-1, U-2, U-3, and U-4 shown in FIG. 9 can represent sections and content information that are posted by the corresponding users. In this case, the viewing user can see content information in the blocks marked U-1, U-2, U-3, and U-4. The dotted arrow line can represent the direction the viewing user is dragging an icon or a section. For example, the users U-1 and U-4 in FIG. 9 are dragged to the icon “Keep.” The users U-2 and U-3 in FIG. 9 are dragged to the icon “Skip.” In this case, in the next renewal of sections, the sections posted by the users U-1 and U-4 are secured and kept while the sections posted by the users U-2 and U-3 are skipped and may not be displayed.

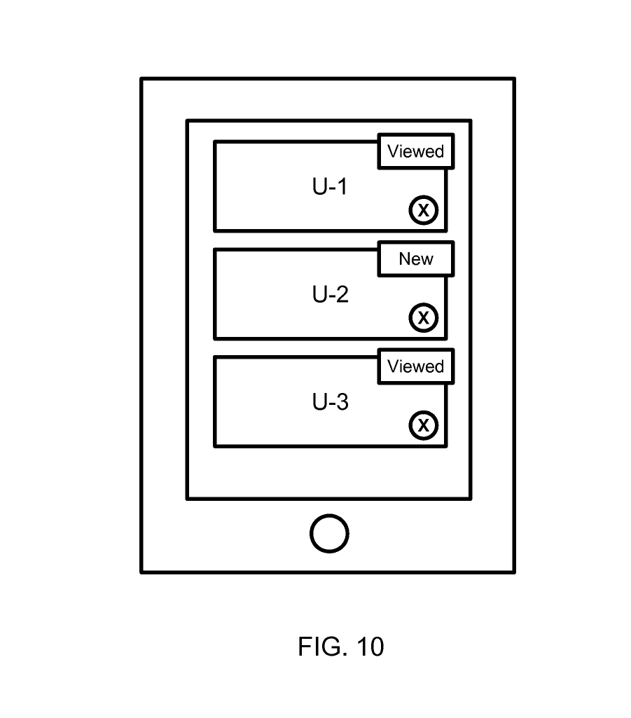

FIG. 10 shows an embodiment of displaying viewing status on sections. With reference to FIG. 10, the sections posted by the users U-1, U-2, and U-3 are displayed on the screen of the mobile device. A small icon is displayed on each of the sections to show the viewing status. For example, a “Viewed” icon is displayed at the top-right corner of the section associated with the user U-1. The “Viewed” icon can represent that this section has been viewed or displayed at least once. A “New” icon is displayed at the top-right corner of the section associated with the user U-2. The “New” icon may represent that the section is first displayed on the screen of the mobile device. Similarly, a “New” icon is displayed at the top-right corner of the section associated with the user U3. It represents that the section posted by the user U-3 has been viewed or displayed at least once. An additional icon “X” is displayed at the bottom-right corner of each of the sections. When the viewing user chooses to touch and select the icon “X,” the corresponding section is tagged or marked so that the section may not be displayed in the next renewal of posted sections.

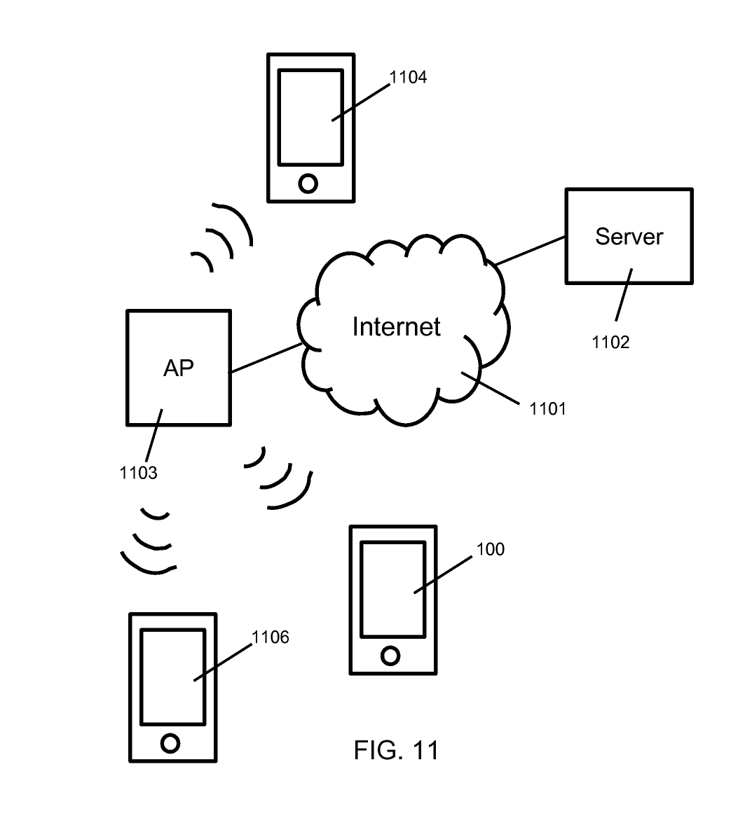

FIG. 11 shows wired and wireless connections between a mobile device and the Internet. A group of executable codes for the social network application can be downloaded from a server 1102, though the Internet, to the mobile device 100. When the social network application is executed in the mobile device 100, it can create an interactive window on the screen of the mobile device 100 and allow the viewing user to view posted sections. The social network application can also allow the viewing user to change settings to view different set of posted sections. The mobile device 100 can access new posted sections from the access point (AP) 1103. The AP 1103 is connected to the Internet. The server 1102 is also connected to the Internet so that the communications between the viewing user and the server 1102 can be made. In one embodiment, the user U-1 uses the mobile device 100, the user U-2 uses a mobile device 1104, and the user U-3 uses a mobile device 1106. In this case, the user U-2 can create a section and post the section using the mobile device 1104. The section can be sent via the AP 1103, through the Internet 1101, to the server 1102. By sending an updating request to the server 1102, the viewing user U-1 can know that a section from U-1 is newly posted. The viewing user U-1 can download the section and then show the section on the mobile device 100. Similarly, when the user U-3 has a new section, the section can be sent to the server 1102 and the viewing user U-1 can know the newly posted section and then download to view it.

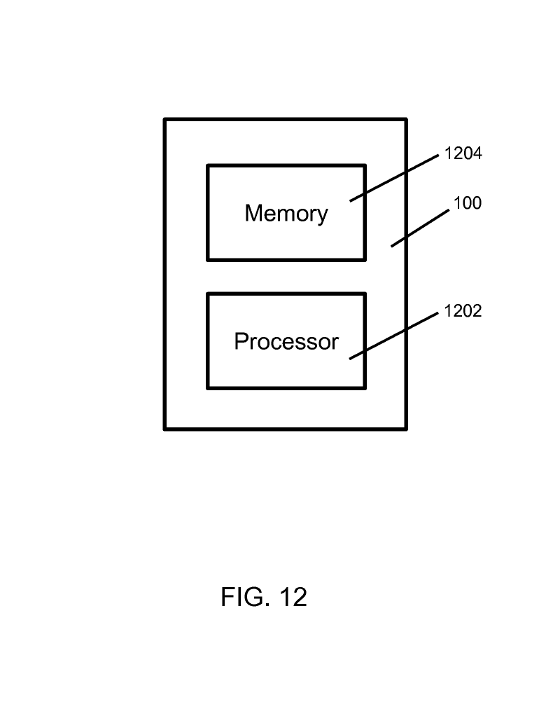

FIG. 12 shows basic blocks in a mobile device. In this embodiment, the mobile device 100 comprises a processor 1202 and a memory 1204. The memory 1204 is to provide space to store programs and data for the mobile device to function properly. The processor 1202 can execute instructions contained in a specific group of codes to perform proper functions.

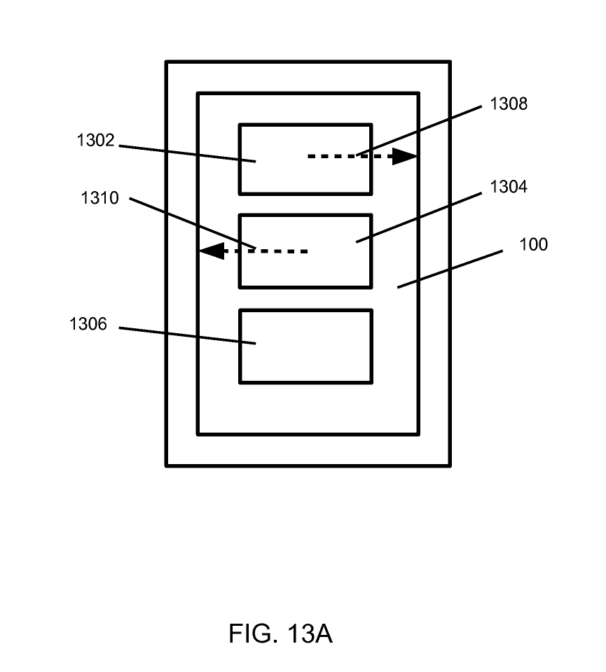

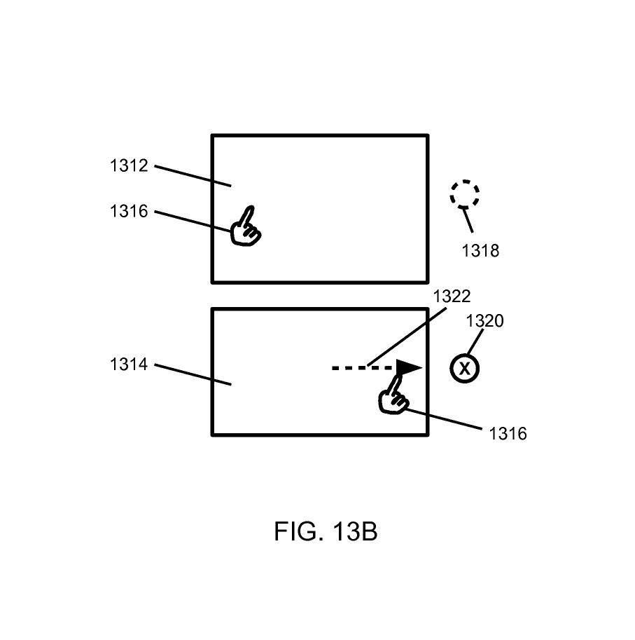

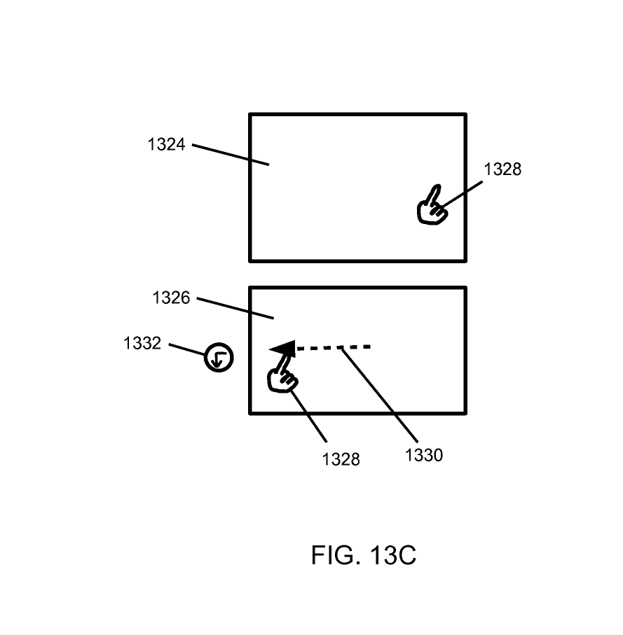

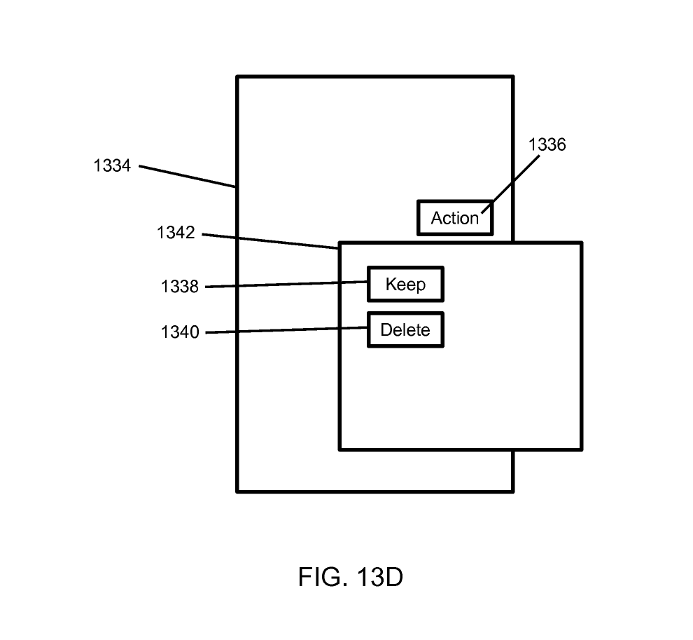

FIG. 13A shows an embodiment of securing or skipping sections. In this embodiment, a section 1302, a section 1304, and a section 1306 are shown on the screen of the mobile device 100. The social network application can allow the viewing user to drag the section 1302 to a direction 1308 to skip the section 1302. In this case, a “Skip” icon is no longer needed for the user to touch in order to skip the section 1302. The social network application can define that moving along the direction 1308 indicates that the corresponding section is going to be skipped while moving along the opposite direction 1310 indicates that the corresponding section is going to be secured. In this embodiment, if the viewing user chooses to drag the section 1310 along the direction 1310, the section 1310 is going to be secured. In some embodiments, the movement for skipping a section has to be greater than a threshold. For example, the social network application can check whether the distance of movement exceeds a certain value M. If the distance of movement exceeds M, then the section is effectively skipped or secured. If the distance of movement does not exceed M, then the section may just bounce back to its normal position.

FIG. 13B shows another embodiment of securing or skipping sections. With reference to FIG. 13B, a section 1312 and a section 1314 are shown on a screen of a mobile device. An image of pointing finger 1316 represents the position of a touch action on the screen. In this embodiment, when the viewing user touches the section 1312 and then drag the section 1312 over a predetermined distance along a direction 1322, a sign 1320 of “X” is shown at a position 1318. When the distance of dragging is not over the predetermined distance, the sign 1320 of “X” is not shown at the position 1318. The display of the sign 1320 is to help the viewing to make sure that the current movement is going to skip the section.

FIG. 13C shows another embodiment of securing or skipping sections. With reference to FIG. 13C, a section 1324 and a section 1326 are shown on a screen of a mobile device. An image of pointing finger 1328 represents the position of a touch action on the screen. In this embodiment, when the viewing user touches the section 1324 and then drag the section 1324 over a predetermined distance along a direction 1330, a sign 1332 is shown. When the distance of dragging is not over the predetermined distance, the sign 1332 is not shown. The display of the sign 1332 is to help the viewing to make sure that the current movement is going to secure the section.

FIG. 13D shows an embodiment of displaying a selection icon. With reference to FIG. 13D, an action icon 1336 is shown in a section 1334. When the user choose to touch and select the action icon 1336, a pull down menu 1342 is displayed. A “keep” icon 1338 and a “delete” icon 1340 are shown in the pull down menu 1342. If the viewing user select the “keep” icon 1338, the section 1334 is tagged or marked so that the viewing user can choose to review the section 1334 later.

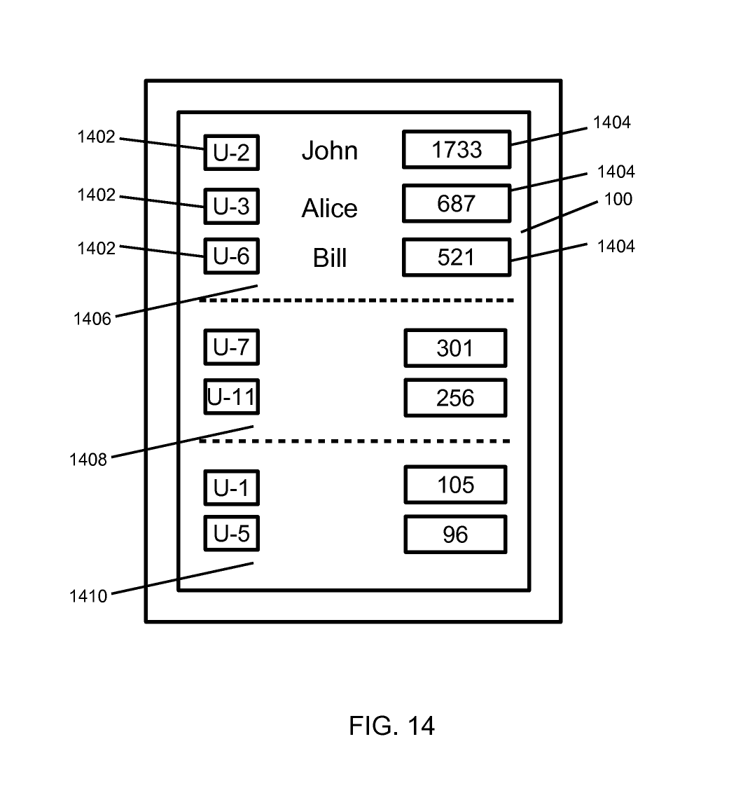

FIG. 14 shows a page that helps to analyse the number of sections posted by different users. With reference to FIG. 14, in this embodiment, a statistical page can be shown by the social network application to show all kinds of statistical numbers. For example, this page can show a ranking of the number of posted sections over a specific period of time. In this page, column 1 shows users 1402, column 2 shows names of the users, and column 3 shows the number 1404 of posted sections over a period of time. In this case, the user U-2's name is John, who provides 1733 sections in the social network application. The user U-3's name is Alice, who provides 687 sections in the social network application. The user U-6's name is Bill, who provides 521 sections in the social network application. In this page, three categories 1406, 1408, and 1410 are provided in this page. The category 1406 shows the users with high number of posted sections. The category 1408 shows the users with medium number of posted sections. The category 1410 shows the users with low number of posted sections. The viewing user can choose to change the priority value of showing sections corresponding to each user according to the statistical numbers in this page.

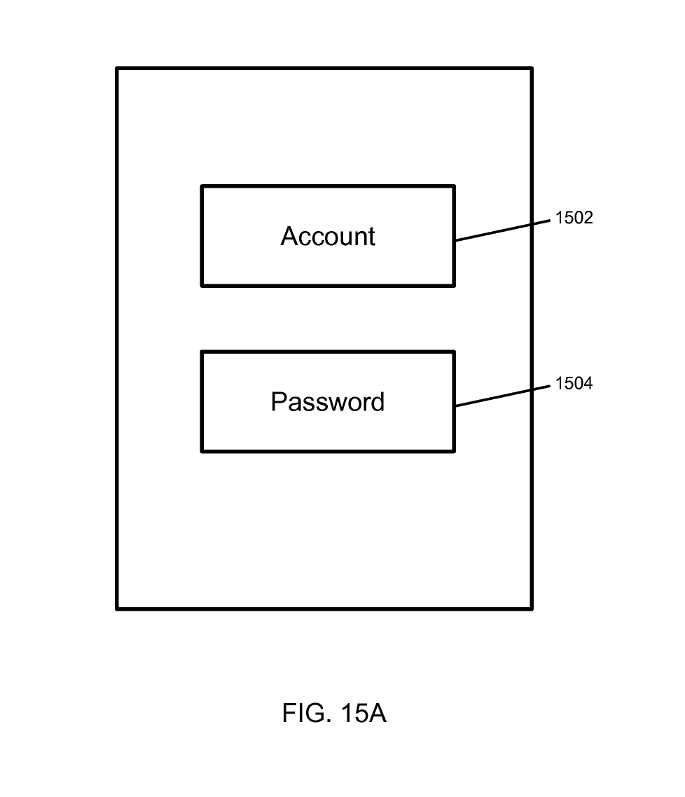

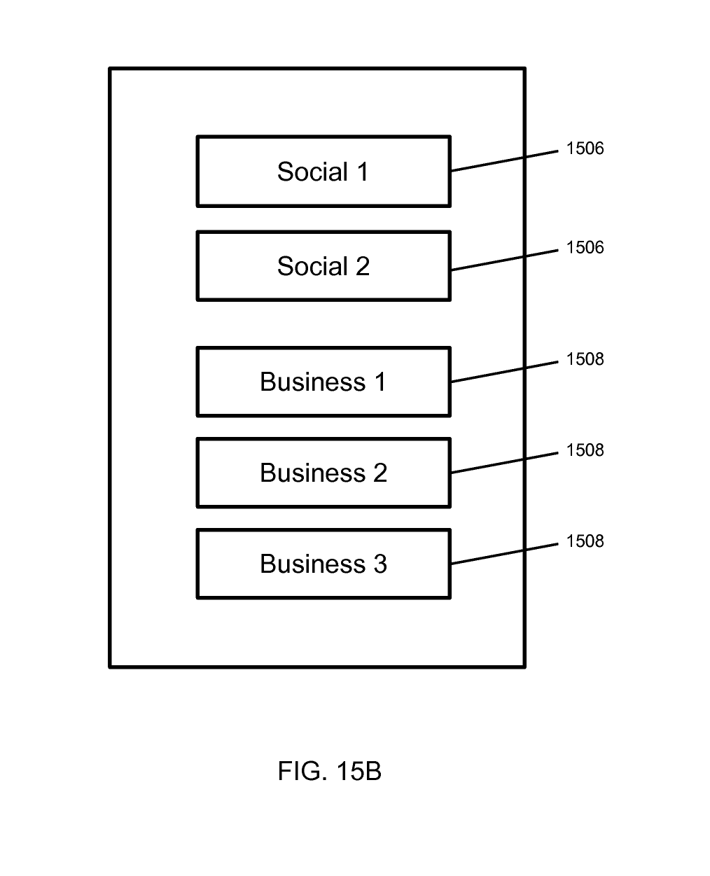

FIG. 15A shows an initial page of a social network application. In this embodiment, two regions 1502 and 1504 are shown when the social network application is opened or started in a mobile device. The region 1502 is for the user to fill out an account for the social network service. The region 1504 is for the user to fill out a password associated with the account.

FIG. 15B shows a next page after the user logs onto the social network application. After the user logs onto the social network application, the user interface shows a plurality of social groups 1506 and business groups 1508 for the user to choose. For example, the user may participate in two social groups 1506 and three business groups 1508. Each of the social groups and the business groups can have common members and also have different members. The members are the users that choose to participate in a specific social group or business group.

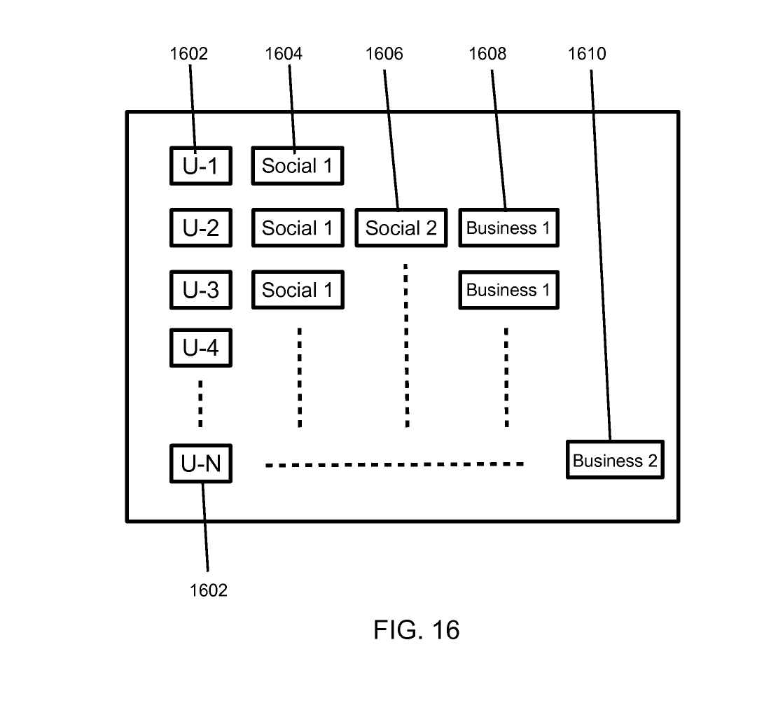

FIG. 16 shows the relationship between different groups and different users. With reference to FIG. 16, column 1 shows all users 1602 that have connections with the viewing user. Column 2 shows which user participates in the social group 1604. Column 3 shows which user participates in the social group 1606. Column 4 shows which user participates in the business group 1608. Column 5 shows which user participates in the business group 1610. When the user chooses one of the group, then the social network application may show only the sections posted by the members that are in the same group. In this way, the viewing user can avoid mixing personal friends with business partners when exchanging information on the social network application.

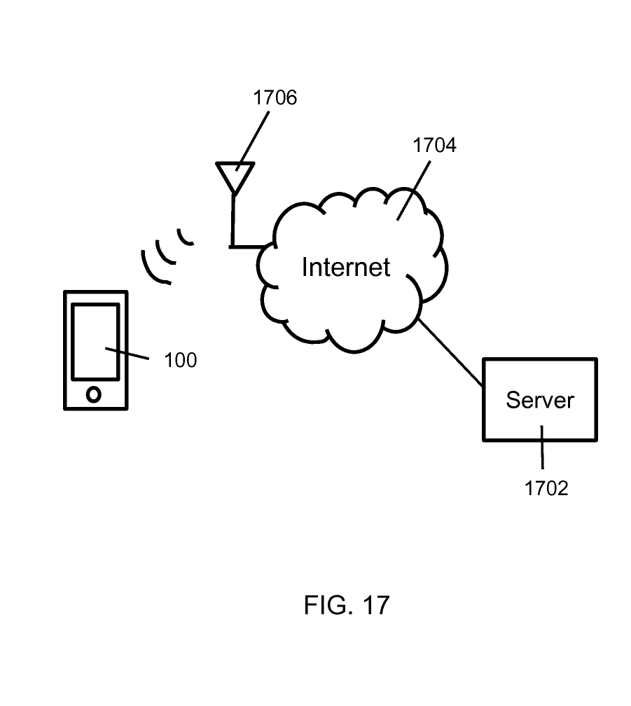

FIG. 17 shows one embodiment of the mobile device's interaction with the Internet and the server. Executable codes of the social network application can be downloaded from a server 1702 though Internet 1704. The way the mobile device 100 obtains the executable codes can be wire-connected or wireless. In one embodiment, the mobile device 100 gets the executable codes via an access point 1706. The access point 1706 is connected to the Internet 1704. In one embodiment, the executable codes are stored in the server 1702. Upon a request, the executable codes are transferred from the server 102, via the Internet 1704, through the access point 1706, and then to the mobile device 100.

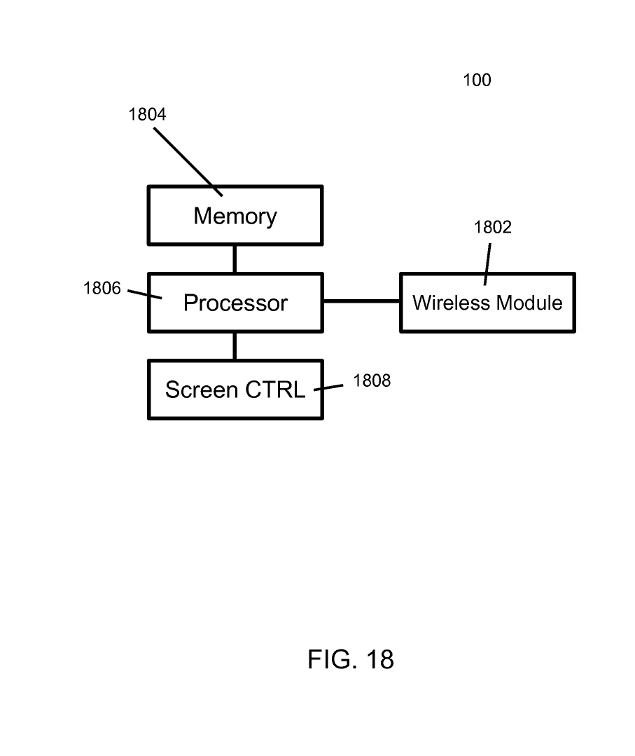

FIG. 18 shows internal modules of the mobile device 100 for one embodiment. The mobile device 100 can have a wireless module 1802, a memory module 1804, a processor 1806, a screen controller 1808, and a screen. The executable codes for the social network application can be downloaded from the Internet through the wireless module 1802. The processor 1806 can instruct to store the executable codes in the memory module 1804. When the processor 1806 can choose to execute the codes depending on users' input. When executed, the mobile device 100 can display an item on the screen. The item is a start point for opening the social network application.

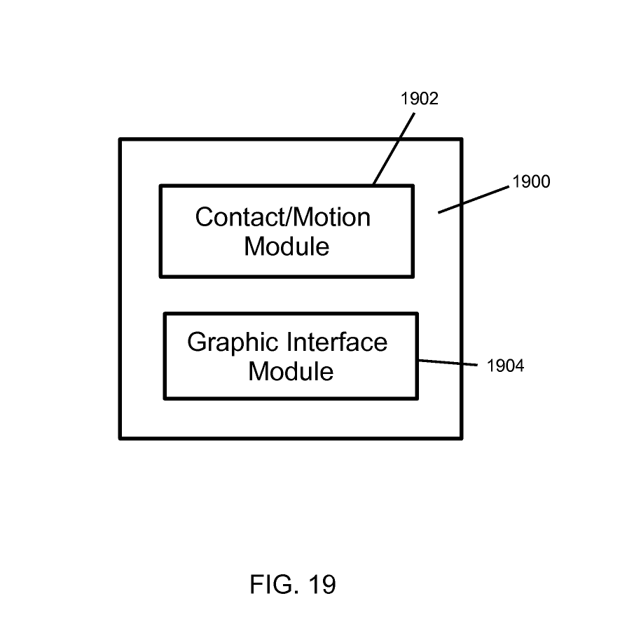

FIG. 19 shows modules contained in a software component. A software component 1900 can be developed to implement the operations and functions described corresponding to FIG. 1, FIG. 2 FIG. 3, FIG. 4, FIG. 6, and FIG. 7. The software component 1900 may include a contact type module 1902 and a graphical interface module 1904. The contact type module 1902 is used to detect whether contact happens. The contact type module 1902 can also check the type of contact. For example, tapping once on the screen and tapping twice on the screen may represent different operations. Referring to FIG. 1 and FIG. 2, in one embodiment, tapping once may represent checking a checkbox. Referring to FIG. 6, in one embodiment, the contact type module 1902 can be used to detect whether a movement of the image component 604 occurs. The movement can be determined by a user's continuous touch with the screen in combination with a moving action of the selected image component 604.

The software component 1900 can be developed using an operation system's SDK (Software Development Kit).

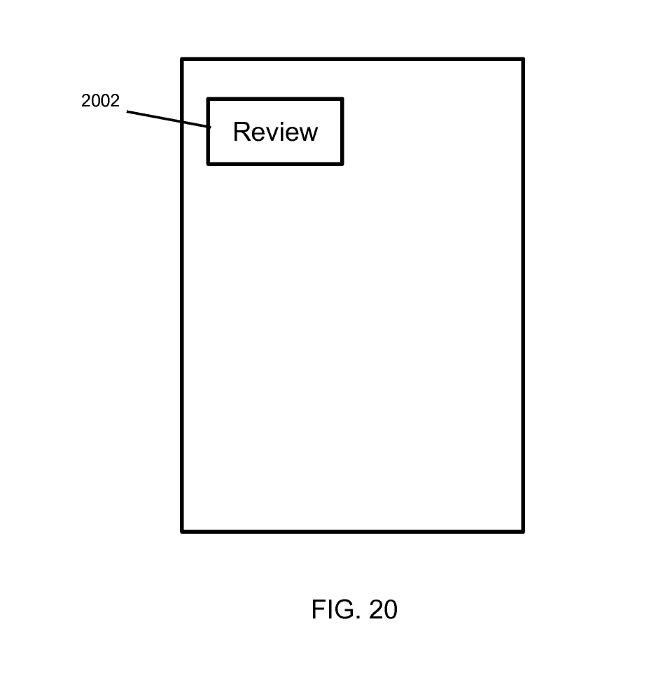

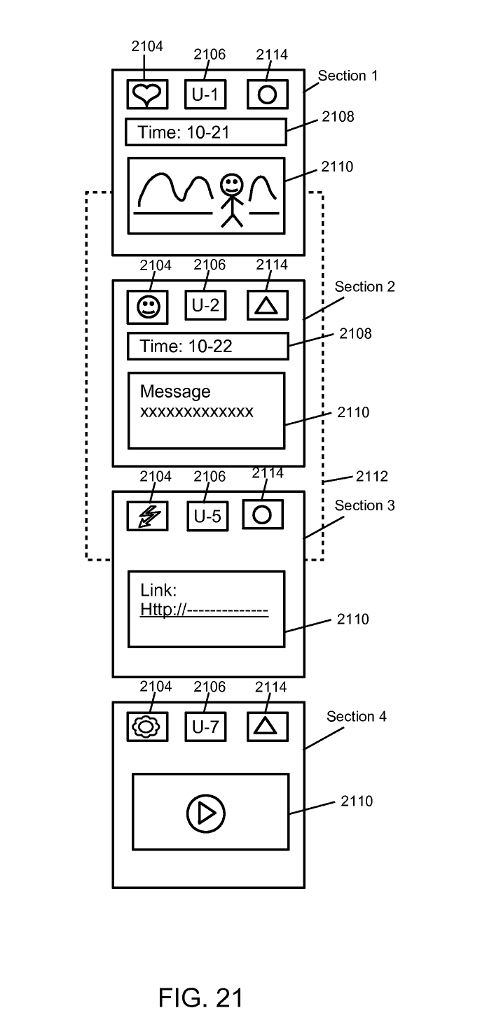

FIG. 20 shows a review icon displayed. After the viewing user selects to secure one or more sections, the secured sections can be tagged or marked or stored in a local memory space. The secured sections can be displayed again in response to the viewing user's request. In this embodiment, a review icon is displayed for the viewing user to select. When the viewing user selects the review icon, the social network application displays the secured sections, which contains content information. The way of displaying the secured section can be the same as the way of displaying normal sections. The difference is that when the viewing user chooses to displayed secured sections, then only the secured sections are displayed. In some embodiments, when the viewing user selects the review icon, only the secured sections and new sections are displayed. In this case, viewed or displayed sections which are not secured are not displayed. The way of displaying the secured sections can be in a similar way that FIG. 21 shows.

FIG. 21 shows an arrangement of sections that can be displayed on a screen of a mobile device. The area 2112 enclosed by dotted lines is an area that can be displayed on the screen of the mobile device. Since the size of the screen is limited, the screen cannot display all sections at once. In this embodiment, section 1, section 2, section 3, and section 4 are arranged in a first sequence. As shown in FIG. 21, at a specific time point, only the area enclosed by dotted lines is displayed on the screen. The viewing user can scroll the first sequence of sections by touching on the screen and then making a movement. If the sequence of sections is scrolled down, the viewing user may be able to see the section 1. If the sequence of sections is scrolled up, the viewing user may be able to see the section 4.

The section 1 can comprise an image icon 2104, a user identity icon 2106, a selection icon 2114, a time record 2108, and a piece of content information 2110. The image icon 2104 may be an image selected by the user U-1 to represent its image. The user identity icon 2106 may show a nick name that selected by the user U-1. The selection icon 2114 can provide options for the viewing user to secure or skip the corresponding section. In the section 1, the piece of content information is a photo posted by the user U-1.

The section 2 can comprise an image icon 2104, a user identity icon 2106, a selection icon 2114, a time record 2108, and a piece of content information 2110. The image icon 2104 may be an image selected by the user U-2 to represent its image. The user identity icon 2106 may show a nick name that selected by the user U-2. The selection icon 2114 can provide options for the viewing user to secure or skip the corresponding section. In the section 2, the piece of content information is a message posted by the user U-2.

The section 3 can comprise an image icon 2104, a user identity icon 2106, a selection icon 2114, a time record 2108, and a piece of content information 2110. The image icon 2104 may be an image selected by the user U-3 to represent its image. The user identity icon 2106 may show a nick name that selected by the user U-3. The selection icon 2114 can provide options for the viewing user to secure or skip the corresponding section. In the section 1, the piece of content information is a hyperlink posted by the user U-3.

The section 4 can comprise an image icon 2104, a user identity icon 2106, a selection icon 2114, a time record 2108, and a piece of content information 2110. The image icon 2104 may be an image selected by the user U-4 to represent its image. The user identity icon 2106 may show a nick name that selected by the user U-4. The selection icon 2114 can provide options for the viewing user to secure or skip the corresponding section. In the section 1, the piece of content information i a video posted by the user U-3.

The time of posting the sections can be a factor for the social network application to give a certain sequence or order of displaying the sections. For example, a later posted section may be displayed at a higher position in the screen than a section posted earlier. The social network application may have other factors to filter the original posted sections to determine the displaying sequence. In this case, the time of posting each section can also be one of the factors for the social network application to determine the sequence.

In one embodiment, the order the section 1, the section 2 , the section 3, and the section 4 is the original order when the viewing user initiates the social network application and selects renewal of posted sections. The viewing user can select to secure the section 1 by changing the status of the selection icon 2114. For example, the circle icon 2114 in the section 1 means that the section 1 is secured by the viewing user. The triangle icon 2114 in the section 2 means that the section 2 is skipped by the viewing user. The circle icon 2114 in the section 3 means that the section 3 is secured by the viewing user. The triangle icon 2114 in the section 4 means that the section 4 is skipped by the viewing user.

When the viewing user updates the sections, the secured sections are shown and the skipped sections are now displayed. That is, only the secured section 1 and section 3 are displayed and the skipped section 2 and section 4 are not displayed. Then the new sequence of sections become first the section 1 and second the section 3. The result of securing or skipping selected by the viewing user become a factor to filter the original sections and to determine the second sequence of order of sections. In some cases, when the viewing user updates the sections, only secured sections and newly posted sections are displayed. In some embodiments, the secured sections are stored in the local memory space. The social network application can prepare a review icon in another page or area for the viewing user to select. When the viewing user selects the review icon, the social network application displays only the secured sections and does not display other sections.

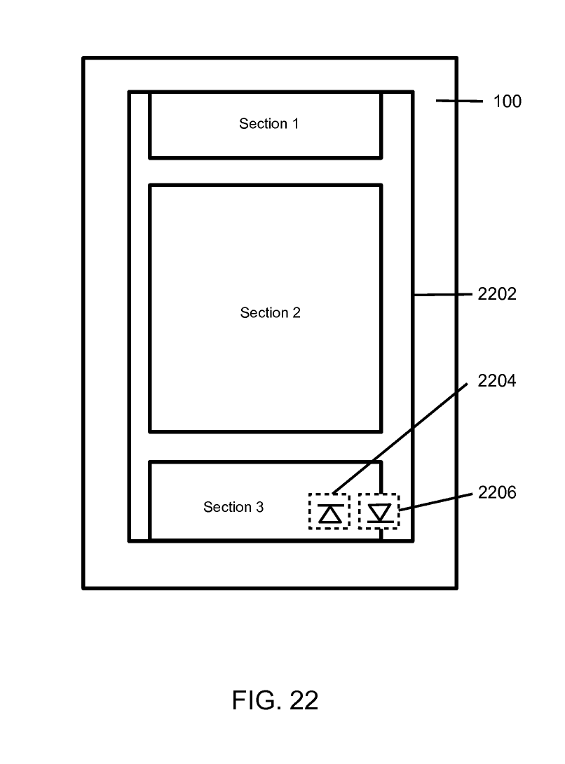

FIG. 22 shows an embodiment of changing screen views. With reference to FIG. 22 and FIG. 21, the size of the screen of the mobile device 100 is limited so that it can only show the section 2 and part of the section 1 and part of the section 3. An upward icon 2204 and a downward icon 2206 can be displayed on the screen of the mobile device 100. When the viewing user selects the upward icon 2204, the screen view can be switched to the top section (section 1 in this case). That is, the upward icon 2204 can help the viewing user to immediately return to the top position of the sequence so that the section 1 can be seen. When the viewing user selected the downward icon 2206, the screen view can be switched to the bottom section (section 4 in this case.) That is, the downward icon can help the viewing user to immediately go to the bottom position of the sequence so that the section 4 can be seen.

The order of steps in the claims does not indicate the steps must follow that order. A change of order is possible and is still within the scope of the corresponding claim.

What is claimed is:

1. A method for interactions between a viewing user and a social network application, the social network application being a group of codes that is executable on a mobile device, the social network application being capable of showing a plurality of continuing sections, wherein each of the sections is associated with one of a plurality of users and comprises a piece of posted information, the method comprises:
showing a first section on a screen of the mobile device, the first section being associated with a first user, the first user being different from the viewing user;
arranging a second section next to the first section, the second section being associated with a second user;
arranging a third section next to the second section, the third section being associated with a third user;
displaying an image component that is associated with the first user;
displaying first content information in the first section; and
displaying a selection icon for the viewing user to select, wherein when the selection icon is selected, the content information is secured for a later review and the section is secured;
wherein the first section, the second section, and the third section are arranged in a sequence so that when the viewing user touches the screen to scroll, the first section, the second section, and the third section move on the screen in a same movement in response to the scrolling.

2. The method of claim 1, wherein a posting time record of each of the plurality of sections is used as a factor to determine an order of displaying the first section, the second section, and the third section on the screen of the mobile device.

3. The method of claim 1, further comprising providing a review icon for the viewing user to select, wherein when the viewing user selects the review icon, the social network application displays the secured content information.

4. The method of claim 3, wherein only the secured sections are displayed when the viewing user selects the review icon.

5. The method of claim 1, wherein in the step of displaying a selection icon, a pull down menu is displayed on the corresponding section.

6. The method of claim 1, wherein the secured sections are stored in a memory space in the mobile device.

7. A method for setting viewing options in a social network application, the social network application being a group of codes that is executable on a mobile device, the social network application being capable of allowing a plurality of users to provide content information and allowing a viewing user to view the content information provided by the plurality of users on the mobile device, the method comprises:
providing a plurality of sections, wherein each section is corresponding to a piece of content information and the piece of content information is provided by one of the plurality of users of the social network application;
providing a first order for the plurality of sections so that when the plurality of sections are displayed on an screen of the mobile device, the sections are in the first order;
providing an image icon to represent the user;
displaying the image icon within the section when the section is displayed on the screen of the mobile device;
providing a selection icon for the viewing user to select, wherein when the selection icon is selected, the piece of content information is secured and the section is secured;
collecting a plurality of secured sections; and
displaying the secured sections in a second order when the viewing user chooses to display the secured sections on the mobile device.

8. The method of claim 7, wherein a posting time record of each of the plurality of sections is used as a factor to determine the first order for the plurality of sections.

9. The method of claim 7, further comprising providing a review icon for the viewing user to select, wherein when the viewing user selects the review icon, the social network application displays the sections according to the result of securing sections.

10. The method of claim 9, wherein only the secured sections are displayed when the viewing user selects the review icon.

11. The method of claim 7, wherein in the step of providing a selection icon, a pull down menu is displayed on the corresponding section.

12. The method of claim 7, wherein the secured sections are stored in a memory space in the mobile device.

13. A method for filtering content information in a social network application, the social network application being a group of codes that is executable on a mobile device, the social network application being capable of allowing a plurality of users to provide content information and allowing a viewing user to view the content information provided by the plurality of users on the mobile device, the method comprises:
collecting a plurality of pieces of content information, the plurality of pieces of content information being transmitted by the plurality of corresponding users;
filtering the plurality of pieces of content information to generate a first sequence of sections for displaying on a mobile device, wherein each section is corresponding to one of the plurality of pieces of content information and wherein each section comprises an image icon representing the user that provides the corresponding piece of content information;
providing a securing option to each section so that a viewing user is allowed to select to secure the corresponding section and to secure the corresponding section;
collecting a result of securing options for the plurality of sections; and
displaying the sections corresponding to the result of securing options in a second sequence in response to a request made by the viewing user, the first order being different from the second order.

14. The method of claim 13, wherein a posting time record of each of the plurality of pieces of content information is used as a filtering factor in the step of filtering the plurality pieces of content information.

15. The method of claim 13, further comprising:
providing a review icon for the viewing user to select, wherein when the viewing user selects the review icon, the social network application displays the sections according to the result of securing options.

16. The method of claim 15, wherein only the secured sections are displayed when the viewing user selects the review icon.

17. The method of claim 13, wherein in the step of providing a selection icon, a pull down menu is displayed on the corresponding section.

18. The method of claim 13, wherein the secured sections are stored in a memory space in the mobile device.
